(19) United States
(12) Patent Application Publication
(10) Pub. No.: US 2025/0086137 A1
(43) Pub. Date: Mar. 13, 2025

(54) USB INTERFACE CIRCUIT

(71) Applicant: ROHM CO., LTD., Kyoto (JP)

(72) Inventor: Nobutaka ITAKURA, Kyoto (JP)

(21) Appl. No.: 18/960,887

(22) Filed: Nov. 26, 2024

Related U.S. Application Data
(63) Continuation of application No. PCT/JP2023/019976, filed on May 29, 2023.

(30) Foreign Application Priority Data
May 30, 2022 (JP) 2022087728

(51) Int. Cl. G06F 13/42; G06F 13/38

(52) U.S. Cl. CPC G06F 13/4282; G06F 13/382; G06F 2213/0042

(57) ABSTRACT

A pull-up circuit contains a variable current source structured to supply current to a CC pin of a connector. A voltage detection circuit is structured to measure voltage at a CC1 pin and at a CC2 pin. A processor is structured to control the variable current source, and to detect moisture adhered to the CC1 pin and the CC2 pin, with reference to an output of the voltage detection circuit.

### BACKGROUND

### 1. Technical Field

The present disclosure relates to a USB interface circuit.

### 2. Description of the Related Art

Battery-driven devices such as smartphone, tablet terminal, notebook computer, portable audio player, and digital camera incorporate a rechargeable secondary battery, together with a charging circuit for charging the same. Some charging circuits are structured to charge the secondary battery, under DC voltage (bus voltage V_{Bus}) externally supplied through a USB cable.

USB Type-C has widely been used as a USB connector shape and a USB standard. FIG. 1 is a block diagram of a USB Type-C system. Each USB Type-C connector has a VBUS pin and a GND pin, as well as two configuration channel (CC) pins (CC1, CC2). The USB standard specifies a source 10 capable of externally supplying electric power, and a sink 20 structured to receive the power from the external. The CC1 and CC2 pins in the source 10 are pulled up by the resistors Rp, meanwhile the CC1 and CC2 pins in the sink 20 are pulled down by the resistors Rd.

A receptacle (connector) 12 of the source 10 and a receptacle 22 of the sink 20 are connected via a cable 30. The source 10 monitors statuses of the CC1 and CC2 pins, and detects connection with the sink 20. More specifically, without the connection with the sink 20, voltage (pulled up to 5 V) will appear at the CC1 and CC2 pins.

Each of plugs 32 and 34 of the cable 30 has a single CC pin, and these CC pins are connected within the cable 30. The plugs 32 and 34 can be inserted, with either side facing up, into the receptacles 12 and 22. With the sides of the plug 32 turned over, as indicated by broken lines, the CC pin of the plug 32 is connected to the CC2 pin of the receptacle 12, and a VCONN pin of the plug 32 is connected to the CC1 pin of the receptacle 12. Similarly, with the sides of the plug 34 turned over, the CC pin of the plug 34 is connected to the CC2 pin of the receptacle 22, and a VCONN pin of the plug 34 is connected to the CC1 pin of the receptacle 22.

Upon connection of the source 10 with the sink 20 as in the state illustrated in FIG. 1, a voltage divided from 5 V by Rp and Rd will appear at the CC1 pin of the source 10. A port controller 14 in the source 10 can detect the connection of the sink 20, and the upside/downside of the cable 30, with reference to the voltage at the CC1 pin. With the sides of the plug 32 turned over, a voltage divided from 5 V by Rp and Rd will appear at the CC2 pin of the source 10. The port controller 14 can detect the connection of the sink 20, and the upside/downside of the cable 30, with reference to the voltage at the CC2 pin.

Adhesion of liquid such as water (referred to as moisture, hereinafter) to the connector of the source 10 would short-circuit the CC1 pin or the CC2 pin, with any other pin. Electric current, if flows through the CC1 pin or the CC2 pin with adhered moisture, would undesirably corrode the electrodes.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a diagram for explaining a USB Type-C;

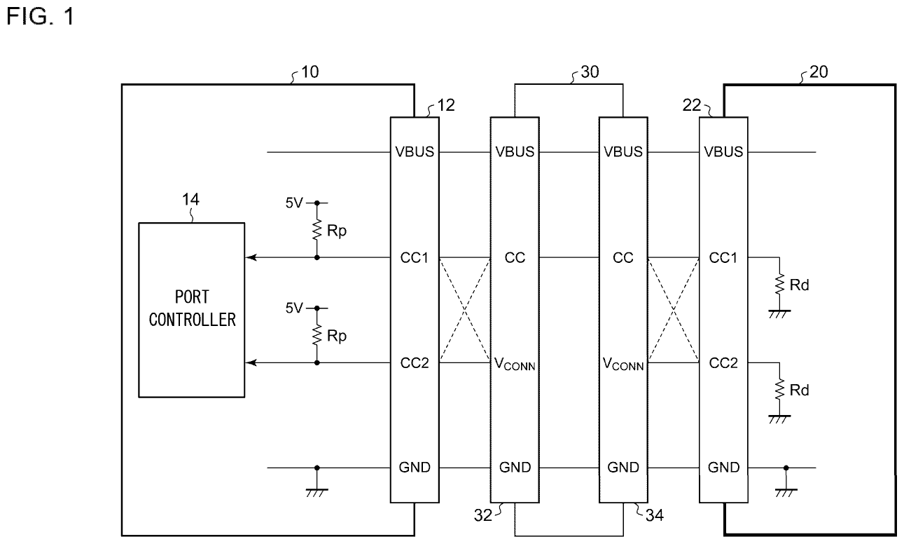

FIG. 2 is a block diagram illustrating an electronic device according to Embodiment 1;

FIG. 3 is an equivalent circuit diagram for explaining detection of moisture between a CC pin and a GND pin in the electronic device illustrated in FIG. 2;

FIG. 4 is an equivalent circuit diagram for explaining detection of moisture between the CC pin and a VBUS pin in the electronic device illustrated in FIG. 2;

FIG. 5 is a circuit diagram illustrating an electronic device according to Embodiment 2;

FIG. 6 is an equivalent circuit diagram for explaining detection of moisture between a CC pin and a GND pin in the electronic device illustrated in FIG. 5; and

FIG. 7 is an equivalent circuit diagram for explaining detection of moisture between the CC pin and a VBUS pin in the electronic device illustrated in FIG. 5.

### DETAILED DESCRIPTION

### Outline of Embodiments

Some exemplary embodiments of the present disclosure will be outlined. This outline will provide introduction into the detailed description that follows, and will brief some concepts of one or more embodiments for basic understanding thereof, without limiting the scope of the invention or disclosure. This outline is not an extensive overview of all possible embodiments, and is therefore intended neither to specify key elements of all embodiments, nor to delineate the scope of some or all of the embodiments. For convenience, the term “one embodiment” may be used to designate a single embodiment (Example or Modified Example), or a plurality of embodiments (Examples or Modified Examples) disclosed in the present specification.

A universal serial bus (USB) interface circuit according to one embodiment is mounted on a device destined to be a source in USB Type-C. The USB interface circuit has a pull-up circuit that contains a variable current source structured to supply current to a CC pin of a connector;
a voltage detection circuit structured to measure voltage at the CC pin; and
a processor structured to control the variable current source, and to detect moisture adhered to the CC pin with reference to an output of the voltage detection circuit.

Meanwhile, an electronic device according to one embodiment relates to the one destined to be a source in universal serial bus (USB) Type-C. The electronic device has a connector having a VBUS pin and a CC pin; a pull-up circuit that contains a variable current source structured to supply current to the CC pin; a voltage detection circuit structured to measure voltage at the CC pin; and a processor structured to control the variable current source, and to detect moisture adhered to the CC pin with reference to an output of the voltage detection circuit.

In these structures, the amount of current supplied to the CC pin is changed on a plurality of levels, and the voltage at the CC pin is detected for each amount of current. This enables measurement of impedance of an object connected to the CC pin, thereby enabling detection of adhesion of moisture.

A USB interface circuit according to one embodiment has a pull-up circuit that contains a variable resistor structured to pull up a CC pin of a connector; a voltage detection circuit structured to measure voltage at the CC pin; and a processor structured to control the variable resistor, and to detect moisture adhered to the CC pin with reference to an output of the voltage detection circuit.

The electronic device according to one embodiment has a connector having a VBUS pin and a CC pin; a pull-up circuit that contains a variable resistor connected to the CC pin; a voltage detection circuit structured to measure voltage at the CC pin; and a processor structured to control the variable resistor, and to detect moisture adhered to the CC pin with reference to an output of the voltage detection circuit.

In these structures, resistivity of the pull-up resistor connected to the CC pin is changed on a plurality of levels, and the voltage at the CC pin is detected for each level of resistivity. This enables measurement of impedance of an object connected to the CC pin, thereby enabling detection of adhesion of moisture.

In one embodiment, the interface circuit may further contain a discharge circuit that is switchable between ON state and OFF state, and discharges the VBUS pin of the connector in the ON state. With the discharge circuit kept in the ON state, the processor may detect adhesion of moisture. Thus the moisture adhesion between the VBUS pin and the CC pin is detectable.

In one embodiment, the processor may detect the moisture in a time division manner.

In one embodiment, the pull-up circuit may be turned off, upon detection of moisture by the processor. This successfully prevents corrosion.

In one embodiment, the voltage detection circuit may contain an A/D converter structured to convert the voltage at the CC pin into a digital value.

In one embodiment, a notification may be issued to a user of the electronic device, upon detection of the moisture by the processor.

In one embodiment, the USB interface circuit may be monolithically integrated on one semiconductor substrate. The term “monolithically integrated” encompasses a case where all components of the circuit are formed on the semiconductor substrate, and a case where essential components of the circuit are integrated, while allowing external provision, for example, of a part of resistors or capacitors for adjusting a circuit constant. The integration of the circuit on one chip can reduce the circuit area, and can keep the characteristics of the circuit elements uniform.

### Embodiments

Preferred embodiments will be explained below, referring to the attached drawings. All similar or equivalent constituents, members and processes illustrated in the individual drawings will be given same reference numerals, so as to properly avoid redundant explanations. The embodiments are merely illustrative, and are not restrictive about the invention. All features and combinations thereof described in the embodiments are not always necessarily essential to the disclosure and invention.

In the present specification, a “state in which a member A is coupled to a member B” includes a case where the member A and the member B are physically and directly coupled, and a case where the member A and the member B are indirectly coupled while placing in between some other member that does not substantially affect the electrically coupled state, or does not degrade the function or effect demonstrated by the coupling thereof.

Similarly, a “state in which a member C is connected (provided) between the member A and the member B” includes a case where the member A and the member C, or the member B and the member C are directly coupled, and a case where they are indirectly coupled, while placing in between some other member that does not substantially affect the electrically coupled state among the members, or does not degrade the function or effect demonstrated by the members.

### Embodiment 1

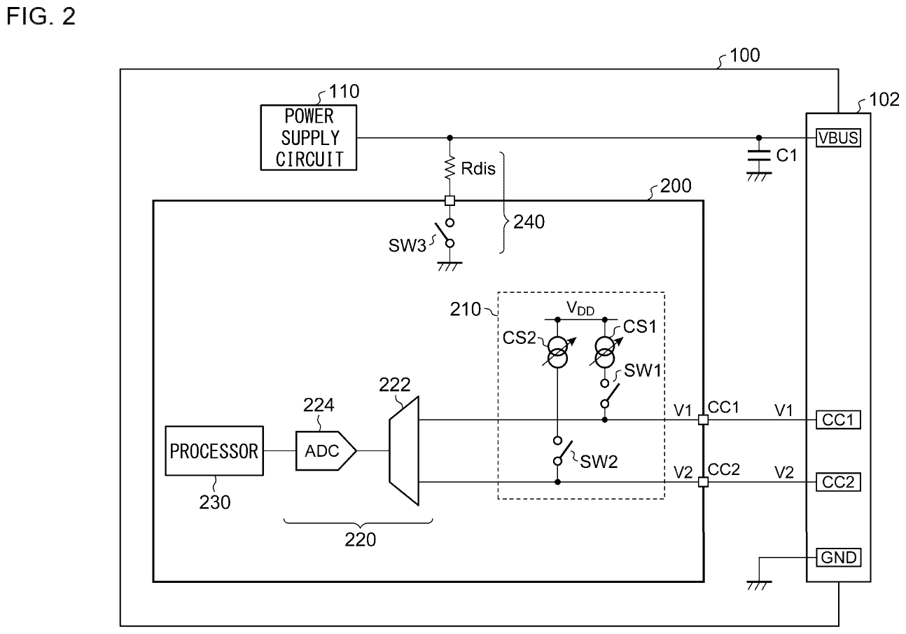

FIG. 2 is a block diagram illustrating an electronic device 100 according to Embodiment 1. The electronic device 100 can operate as a source in USB Type-C. The electronic device 100 may be an AC adapter, a computer, a tablet terminal, a smartphone, or the like.

The electronic device 100 has a connector 102, a USB interface circuit 200, and a power supply circuit 110.

The connector 102 has a VBUS pin, a CC1 pin, a CC2 pin, and a GND pin. The connector 102 may be a receptacle into which a USB cable is inserted, or may be a captive cable directly connectable to a receptacle of a sink.

Output of the power supply circuit 110 is connected to the VBUS pin of the connector 102. The power supply circuit 110 generates bus voltage V_{BUS}.

The USB interface circuit 200 is connected to the CC1 pin and the CC2 pin of the connector 102. The CC1 pin and the CC2 pin are collectively referred to as a CC pin. The USB interface circuit 200 contains a pull-up circuit 210, a voltage detection circuit 220, a processor 230, and a discharge circuit 240. The USB interface circuit 200 may be a functional integrated circuit (IC) monolithically integrated on one semiconductor substrate. This type of IC is referred to as a port controller.

The pull-up circuit 210 contains a variable current source CS1 structured to supply current to the CC1 pin of the connector 102, and a variable current source CS2structured to supply current to the CC2 pin. The currents generated by the current sources CS1 and CS2 are switchable in a plurality (n+1) of levels from the amounts of current I₀ to Iₙ. I₀ is a standard value used for detecting an electronic device destined to be a sink, and is typically set to 80 μA.

The amounts of current I₁ to Iₙ are used to detect moisture. Given n=3, exemplary settings may include I₁=1 μA, I₂=10 μA, and I₃=100 μA.

The pull-up circuit 210 further contains switches SW1 and SW2. The switch SW1 is provided on a current path of the current source CS1, meanwhile the switch SW2 is provided on a current path of the current source CS2. Upon turning-off of the switches SW1 and SW2, the current sources CS1 and CS2 will turn in the OFF state.

The voltage detection circuit 220 is structured to measure voltage V1 at the CC1 pin and voltage V2 at the CC2 pin. For example, the voltage detection circuit 220 contains a multiplexer 222 and an A/D converter 224. The multiplexer 222 receives voltages V1 and V2, and selects one of them. The A/D converter 224 converts the voltage selected by the multiplexer 222 into a digital signal.

The processor 230 controls the variable current sources CS1 and CS2. The processor 230 also detects moisture adhered to the CC1 pin and the CC2 pin, with reference to an output of the voltage detection circuit 220.

The discharge circuit 240 is provided to discharge the capacitor C1 connected to the VBUS pin. The discharge circuit 240 contains a discharge resistor Rdis and a discharge switch SW3, by which the ON state and the OFF state are switchable.

The structures of the USB interface circuit 200 and the electronic device 100 have been described. Next, operations of the USB interface circuit 200 will be described.

The USB interface circuit 200 is switchable between a first mode for detecting a device destined as the sink, and a second mode for detecting adhesion of moisture such as water droplet. In the first mode and the second mode, the switches SW1 and SW2 of the pull-up circuit 210 stays in the ON state. For example, the USB interface circuit 200 may be periodically switchable between the first mode and the second mode, in a time division manner.

In the first mode, the amount of current I₀ generated by the current sources CS1 and CS2 is set to 80 μA. Assuming now a pull-down Rd (5.1 kΩ) of the device destined to be the sink is connected to the CC1 pin, voltage V1=Rd×I₀=0.4 V will appear at the CC1 pin. Upon detection of this state by the voltage detection circuit 220 or any unillustrated comparator, it will be determined that the sink was connected. The same applies to the CC2 pin.

In the second mode, the amount of current generated by the current source CS1 is set to the amounts of current I₁, I₂, and I₃, other than I₀. If the CC1 pin has no device destined to be the sink connected thereto, and has no moisture adhered thereto, the voltage V1 appears at the CC1 pin will be given by power supply voltage V_{DD}=5 V, for any of the amounts of current I₁, I₂, and I₃. The same applies to the CC2 pin.

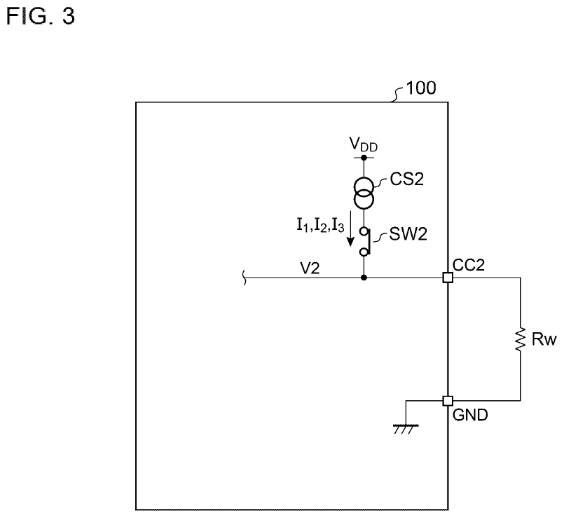

FIG. 3 is an equivalent circuit diagram for explaining detection of moisture between the CC pin and the GND pin in the electronic device 100 illustrated in FIG. 2. Assuming now that the CC2 pin and the GND pin are electrically connected, under the influence of moisture. Resistance component of moisture will be given by Rw.

Upon switching of the amount of current of the current source CS2 among I₁, I₂, and I₃, the voltage V2 at the CC2 pin will vary in three voltage levels as follows:

$$V 2 [ 1 ] = {I}_{1} \times Rw ;$$

$$V 2 [ 2 ] = {I}_{2} \times Rw ;$$

$$and$$

$$V 2 [ 3 ] = {I}_{3} \times Rw .$$

V2[j] represents the voltage at the CC2 pin, corresponding to the amount of current Iⱼ.

The resistance value Rw of moisture is given by:

$$Rw = ρ \times l / S ,$$

with use of electrical resistivity ρ, length l, and cross-sectional area S of the moisture.

The electrical resistivity ρ of moisture depends on type of moisture and impurity concentration, and roughly falls in the range from several kΩ·cm to several MΩ·cm. For example, tap water typically has an electric resistivity of approximately 5 kΩ·cm. Given that the water droplet between the CC pin and the GND pin has a length l of 0.1 cm, and a cross-sectional area S of 0.01 cm², then Rw=50 kΩ holds. The voltage V2 at the CC2 pin is then given by:
V2[1]=5 mV;
V2[2]=50 mV; and
V2[3]=500 mV.

The moisture, whose cross-sectional area reduced down to 1/10, will have a Rw of 500 kΩ. The voltage V2 is then given by:
V2[1]=50 mV;
V2[2]=500 mV; and
V2[3]=5 V.

The processor 230 can detect adhesion of moisture, with reference to the voltage values V2[1] to V2[3]. Adhesion of moisture between the CC1 pin and the GND pin is detectable by the determination on the CC1 pin conducted in the same way.

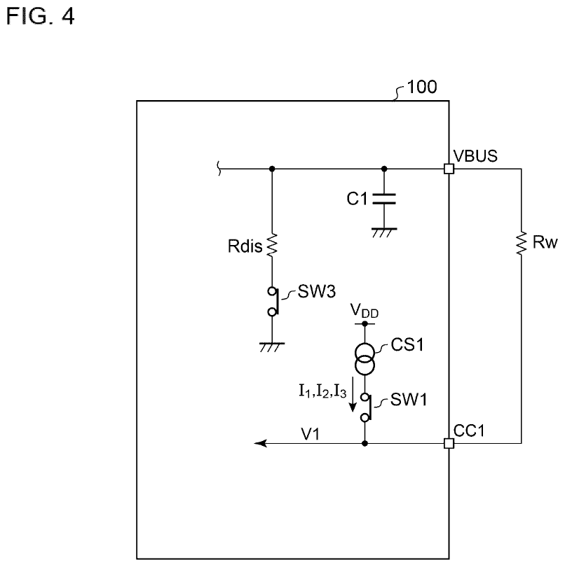

Next, detection of adhesion of moisture between the CC pin and the power supply line VBUS will be described. FIG. 4 is an equivalent circuit diagram for explaining detection of moisture between the CC pin and the VBUS pin in the electronic device 100 illustrated in FIG. 2. Assuming now that the CC1 pin and the VBUS pin are electrically connected, under the influence of moisture. For detection of moisture between the CC1 pin and the VBUS pin, a discharge switch SW3 is turned on. This connects the VBUS terminal and the ground, via a discharge resistor Rdis.

In this state, upon switching of the amount of current of the current source CS2 among I₁, I₂, and I₃, the voltage V1 at the CC1 pin will vary in three voltage levels as follows:

$$V 1 [ 1 ] = {I}_{1} \times ( Rw + Rdis ) ;$$

$$V 1 [ 2 ] = {I}_{2} \times ( Rw + Rdis ) ;$$

$$and$$

$$V 1 [ 3 ] = {I}_{3} \times ( Rw + Rdis ) .$$

When Rw>>Rdis holds, then

$$V 1 [ 1 ] \approx {I}_{1} \times Rw ;$$

$$V 1 [ 2 ] \approx {I}_{2} \times Rw ;$$

$$and$$

$$V 1 [ 3 ] \approx {I}_{3} \times Rw$$

will be given. V1[j] represents the voltage at the CC1 pin, corresponding to the amount of current Iⱼ.

By thus varying the amount of current of the current source CS1, among I₁, I₂, and I₃, while keeping the discharge circuit 240 in the ON state, it now becomes possible to detect moisture between the CC1 pin and the VBUS pin.

The processor 230 may turn off the switches SW1 and SW2, upon detection of moisture. This successfully cut off current which possibly flows through the moisture, and thus can prevent corrosion.

Upon detection of moisture, the user of the electronic device 100 may be notified that the moisture has adhered to the connector 102, instead of, or in addition to turning off of the switches SW1 and SW2. More specifically, upon detection of moisture, the processor 230 notifies an unillustrated host controller (application processor) of the detection. In response to the notification, the host controller may display, on a display unit, a message that indicates adhesion of moisture.

### Embodiment 2

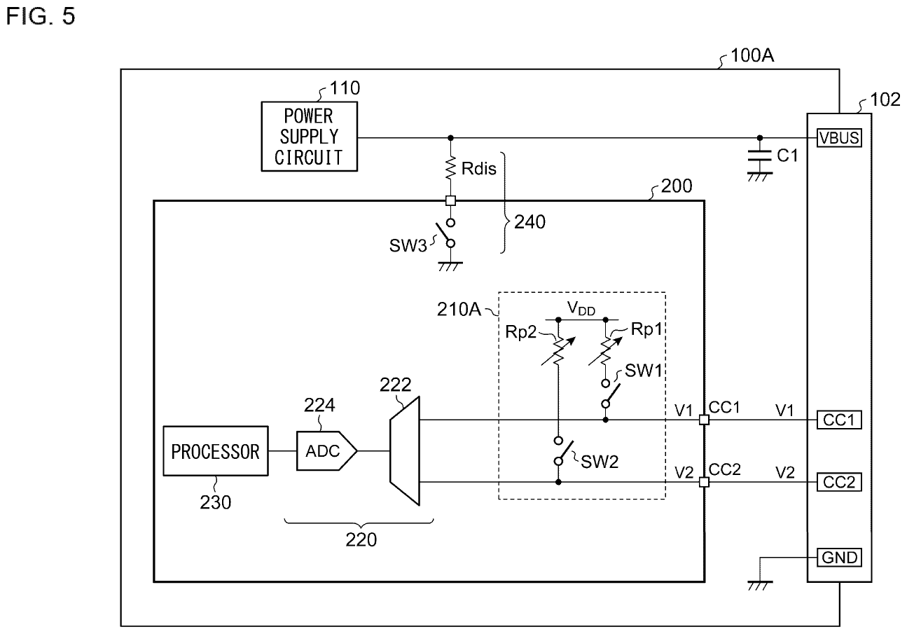

FIG. 5 is a circuit diagram illustrating an electronic device 100A according to Embodiment 2. A pull-up circuit 210A contains variable pull-up resistors Rp1 and Rp2, in place of the current sources CS1 and CS2.

The pull-up resistors Rp1 and Rp2 are switchable in a plurality (n+1) of levels from the resistance values R₀ to Rₙ. R₀ is a standard value used for detecting an electronic device destined to be a sink, and is set to any one of 56 kΩ, 22 kΩ, and 10 kΩ according to current supply capacity.

Resistance values R₁ to Rₙ are used to detect moisture. Given n=3, then exemplary settings may include R₁=1 kΩ, R₂=10 kΩ, and R₃=100 kΩ.

The structure of the electronic device 100A has been described. Next, operations thereof will be explained.

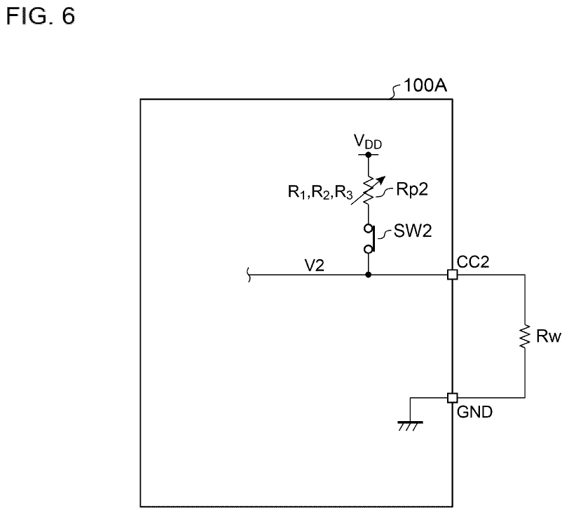

FIG. 6 is an equivalent circuit diagram for explaining detection of moisture between the CC pin and the GND pin in the electronic device 100A illustrated in FIG. 5. Assuming now that the CC2 pin and the GND pin are electrically connected, under the influence of moisture. Resistance component of moisture will be given by Rw.

Upon switching of the resistance value of the pull-up resistor Rp2 among R₁, R₂, and R₃, the voltage V2 at the CC2 pin will vary in three voltage levels as follows:

$$V 2 [ 1 ] = {V}_{DD} \times Rw / ( {R}_{1} + Rw ) ;$$

$$V 2 [ 2 ] = {V}_{DD} \times Rw / ( {R}_{2} + Rw ) ;$$

$$and$$

$$V 2 [ 3 ] = {V}_{DD} \times Rw / ( {R}_{3} + Rw ) .$$

Given Rw=50 kΩ, then

$$V 2 [ 1 ] = 4.9 V ;$$

$$V 2 [ 2 ] = 4.17 V ;$$

$$and$$

$$V 2 [ 3 ] = 1.67 mV$$

hold.

Given Rw=500 kΩ, then
V2[1]=4.99 V;
V2[2]=4.9 V; and
V2[3]=4.17 V
   hold.

The processor 230 can detect adhesion of moisture, with reference to the voltage values V2[1] to V2[3]. Adhesion of moisture between the CC1 pin and the GND pin is detectable by the determination on the CC1 pin conducted in the same way.

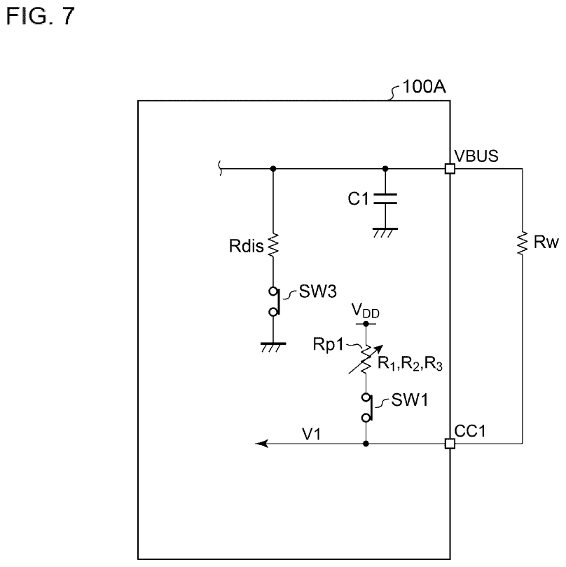

Next, detection of adhesion of moisture between the CC pin and the power supply line VBUS will be described. FIG. 7 is an equivalent circuit diagram for explaining detection of moisture between the CC pin and the VBUS pin in the electronic device 100A illustrated in FIG. 5. Assuming now that the CC1 pin and the VBUS pin are electrically connected, under the influence of moisture. For detection of moisture between the CC1 pin and the VBUS pin, a discharge switch SW3 is turned on. This connects the VBUS terminal and the ground, via a discharge resistor Rdis.

In this state, upon switching of the resistance value of the pull-up resistor Rp1 among R₁, R₂, and R₃, the voltage V1 at the CC1 pin will vary in three resistance values as follows:

$$V 1 [ 1 ] = {V}_{DD} \times ( Rw + Rdis ) / ( {R}_{1} + Rw + Rdis ) ;$$

$$V 1 [ 2 ] = {V}_{DD} \times ( Rw + Rdis ) / ( {R}_{2} + Rw + Rdis ) ;$$

$$and$$

$$V 1 [ 3 ] = {V}_{DD} \times ( Rw + Rdis ) / ( {R}_{3} + Rw + Rdis ) .$$

V1[j] represents the voltage at the CC1 pin, corresponding to the amount of current Iⱼ.

By thus varying the resistance values of the pull-up resistor Rp among R₁, R₂, and R₃, while keeping the discharge circuit 240 in the ON state, it now becomes possible to detect moisture between the CC1 pin and the VBUS pin.

### Modified Examples

It is to be understood by those skilled in the art that the aforementioned embodiments are merely illustrative, and that combinations of the individual constituents or processes may be modified in various ways. Such modified examples will be explained below.

### Modified Example 1

The embodiments have integrated the processor 230 and the voltage detection circuit 220, on the same IC (port controller) together with the pull-up circuit 210. This is, however, not restrictive. For example, the processor 230 may be implemented on a microcontroller, separately from the port controller. Alternatively, the A/D converter 224 may be implemented with use of an A/D converter in the microcontroller.

### Modified Example 2

The embodiments have described a case where the voltage detection circuit 220 contains the A/D converter 224. This is, however, not restrictive. For example, the voltage detection circuit 220 may contain a comparator that compares the voltages V1 and V2 at the CC1 pin and the CC2 pin, with a threshold voltage. The threshold voltage V_{TH} may be variable.

It is to be understood by those skilled in the art that these embodiments are merely illustrative, that the individual constituents or combinations of various processes may be modified in various ways, and that also such modifications fall within the scope of the present disclosure.

### Supplement

In one aspect, the technology disclosed in the present specification may be understood as follows.

### Item 1

A universal serial bus (USB) interface circuit to be mounted on a device destined to be a source in USB Type-C, the USB interface circuit includes:
a pull-up circuit that contains a variable current source structured to supply current to a CC pin of a connector;
a voltage detection circuit structured to measure voltage at the CC pin; and
a processor structured to control the variable current source, and to detect moisture adhered to the CC pin with reference to an output of the voltage detection circuit.

### Item 2

A universal serial bus (USB) interface circuit to be mounted on a device destined to be a source in USB Type-C, the USB interface circuit including:
a pull-up circuit that contains a variable resistor structured to pull up a CC pin of a connector;
a voltage detection circuit structured to measure voltage at the CC pin; and
a processor structured to control the variable resistor, and to detect moisture adhered to the CC pin with reference to an output of the voltage detection circuit.

### Item 3

The USB interface circuit according to item 1 or 2, further including a discharge circuit structured to be switchable between ON state and OFF state, and to discharge in the ON state a VBUS pin of the connector,

wherein the processor is structured to detect adhesion of the moisture between the VBUS pin and the CC pin, in the ON state of the discharge circuit.

### Item 4

The USB interface circuit according to any one of items 1 to 3, wherein the processor is structured to detect the moisture in a time division manner.

### Item 5

The USB interface circuit according to any one of items 1 to 4, structured to turn off the pull-up circuit, upon detection of the moisture by the processor.

### Item 6

The USB interface circuit according to any one of items 1 to 5, wherein the voltage detection circuit contains an A/D converter structured to convert the voltage at the CC pin into a digital value.

### Item 7

The USB interface circuit according to any one of items 1 to 6, being monolithically integrated on one semiconductor substrate.

### Item 8

An electronic device destined to be a source in universal serial bus (USB) Type-C, the electronic device comprising:
a connector having a VBUS pin and a CC pin;
a pull-up circuit that contains a variable current source structured to supply current to the CC pin;
a voltage detection circuit structured to measure voltage at the CC pin; and
a processor structured to control the variable current source, and to detect moisture adhered to the CC pin with reference to an output of the voltage detection circuit.

### Item 9

An electronic device destined to be a source in universal serial bus (USB) Type-C, the electronic device including:
a connector having a VBUS pin and a CC pin;
a pull-up circuit that contains a variable resistor connected to the CC pin;
a voltage detection circuit structured to measure voltage at the CC pin; and
a processor structured to control the variable resistor, and to detect moisture adhered to the CC pin with reference to an output of the voltage detection circuit.

### Item 10

The electronic device according to item 8 or 9, further including a discharge circuit structured to be switchable between ON state and OFF state, and to discharge in the ON state the VBUS pin of the connector,

wherein the processor is structured to detect adhesion of moisture between the VBUS pin and the CC pin, in the ON state of the discharge circuit.

### Item 11

The electronic device according to any one of items 8 to 10, wherein the processor is structured to detect the moisture in a time division manner.

### Item 12

The electronic device according to any one of items 8 to 11, structured to turn off the pull-up circuit, upon detection of the moisture.

### Item 13

The electronic device according to any one of items 8 to 12, structured to issue a notification to a user of the electronic device, upon detection of the moisture.

What is claimed is:

1. A universal serial bus (USB) interface circuit to be mounted on a device destined to be a source in USB Type-C, the USB interface circuit comprising:
a pull-up circuit that contains a variable current source structured to supply electric current to a CC pin of a connector;
a voltage detection circuit structured to measure voltage at the CC pin; and
a processor structured to control the variable current source, and to detect moisture adhered to the CC pin with reference to an output of the voltage detection circuit.

2. A universal serial bus (USB) interface circuit to be mounted on a device destined to be a source in USB Type-C, the USB interface circuit comprising:
a pull-up circuit that contains a variable resistor structured to pull up a CC pin of a connector;
a voltage detection circuit structured to measure voltage at the CC pin; and
a processor structured to control the variable resistor, and to detect moisture adhered to the CC pin with reference to an output of the voltage detection circuit.

3. The USB interface circuit according to claim 1, further comprising
a discharge circuit structured to be switchable between ON state and OFF state, and to discharge in the ON state a VBUS pin of the connector,
wherein the processor is structured to detect adhesion of the moisture between the VBUS pin and the CC pin, in the ON state of the discharge circuit.

4. The USB interface circuit according to claim 1, wherein the processor is structured to detect the moisture in a time division manner.

5. The USB interface circuit according to claim 1, structured to turn off the pull-up circuit, upon detection of the moisture by the processor.

6. The USB interface circuit according to claim 1, wherein the voltage detection circuit contains an A/D converter structured to convert the voltage at the CC pin into a digital value.

7. The USB interface circuit according to claim 1, being monolithically integrated on one semiconductor substrate.
